(19) United States
(12) Patent Application Publication
(10) Pub. No.: US 2016/0065079 A1
(43) Pub. Date: Mar. 3, 2016

(54) POWER TRANSFER SYSTEM

(71) Applicant: KETTERING UNIVERSITY, Flint, MI (US)

(72) Inventors: Hua Bai, Flint, MI (US); Xuan Zhou, Novi, MI (US)

(21) Appl. No.: 14/843,307

(22) Filed: Sep. 2, 2015

Related U.S. Application Data
(60) Provisional application No. 62/045,055, filed on Sep. 3, 2014.

(51) Int. Cl. H02M 3/335

(52) U.S. Cl. CPC H02M 3/33507

(57) ABSTRACT

A power transfer system and method are provided for transferring power from an AC supply outputting an AC voltage. The system includes a controller and a primary rectifier coupled to the controller and to the AC supply for converting the AC voltage to a DC bus voltage. An inverter is coupled with the primary rectifier and the controller for converting the DC bus voltage to a primary AC voltage. A primary coil is connected to the inverter. A secondary coil is in communication with the primary coil for producing an induced AC voltage. A secondary rectifier is connected to the secondary coil for rectifying the induced AC voltage to a secondary DC voltage. At least one sensor is connected to the secondary rectifier for outputting a signal proportional to the secondary DC voltage and the controller is configured to vary the DC bus voltage based on the signal from the sensor.

### CROSS REFERENCE TO RELATED APPLICATIONS

This application claims the benefit of and priority to U.S. Provisional Application Ser. No. 62/045,055 filed Sep. 3, 2014, which is incorporated herein by reference in its entirety.

### BACKGROUND OF THE INVENTION

1. Field of the Invention

The present disclosure relates generally to a power transfer system and in particular, a power transfer system for electric vehicles and other related power transfer applications.

2. Related Art

Electronic devices such as laptops, cell phones, smart phones, smart devices, smart watches, tablets, MP3 players, digital media players generally require batteries and in some cases employ wireless power transfer (WPT) systems in order to charge the batteries of the devices. Charging systems for electric and/or hybrid vehicles may also utilize WPT systems. Given the increasing demand for hybrid and electric vehicles as well as increased use of electronic devices, automotive companies and electronic device manufacturers are each motivated to design and manufacture improved high power WPT systems for vehicles and non-vehicle electronic devices respectively.

Many WPT systems utilize a topology involving the resonance or transfer of energy between two coils forming a transformer, with one coil acting as a power transmitter (i.e. primary coil) and the other acting as the receiver (i.e. secondary coil). The two coils may for example have a large air gap (e.g. greater than 10 centimeters). At least one capacitor can also be used in parallel and/or series with each of the two coils to enhance the electromagnetic field link between the two coils and allow highly effective power transfer. An alternating current (AC) voltage is generally supplied to the primary coil which induces an alternating voltage in the secondary coil. The induced voltage in the secondary coil is used to charge the battery of the vehicle or electronic device.

Power transfer systems may use an inverter that includes electronic switches (e.g. transistors) that are periodically switched on and off to produce the necessary AC voltage which is supplied to the primary coil. In order to adjust the amount of induced voltage in the secondary coil, the switching frequency of the inverter may be adjusted. However, various problems arise when the switching frequency is adjusted in this manner. Adjusting the switching frequency can lead to big changes in the induced voltage in the secondary coil (i.e. charging voltage). Additionally, as switching frequency increases, the system's overall efficiency decreases due to high switching loss. Existing engineering standards such as SAE J-2954 may also require wireless chargers to operate at specific frequencies. As such, there is an increasing need for power transfer systems which address the problems of known systems.

### SUMMARY AND ADVANTAGES OF THE INVENTION

This section provides a general summary of the present disclosure and is not intended to be interpreted as a comprehensive disclosure of its full scope or all of its features, aspects, and objectives. Accordingly, the aspects of the present disclosure provide a power transfer system for transferring power to a battery of an electric device and a method of transferring power utilizing the power transfer system.

It is an aspect of the present disclosure to provide a power transfer system for transferring power from an AC supply outputting an AC voltage and including a controller. A primary rectifier defines a first primary node and a second primary node and is connected to the AC supply for converting the AC voltage to a DC bus voltage. An inverter is coupled with the primary rectifier and the controller for converting the DC bus voltage to a primary AC voltage. A primary coil is connected to the inverter for producing an alternating magnetic field in response to receiving the primary AC voltage. A secondary coil is in communication with the primary coil for producing an induced AC voltage in response to the alternating magnetic field from the primary coil. A secondary rectifier is connected to the secondary coil for rectifying the induced AC voltage from the secondary coil to a secondary DC voltage. The primary rectifier includes a first rectifier switch connected between the second primary node and the AC supply and coupled to the controller. A first rectifier diode is connected between the first primary node and the AC supply. The primary rectifier also includes a second rectifier switch connected between the second primary node and the AC supply and coupled to the controller. A second rectifier diode is connected between the first primary node and the AC supply. The controller is configured to control the first rectifier switch and the second rectifier switch for varying the DC bus voltage to produce a desired secondary DC voltage.

It is another aspect of the present disclosure to provide a power transfer system for transferring power from an AC supply outputting an AC voltage and including a controller. A filter is connected to the AC supply for filtering out undesirable frequencies from the AC voltage and outputting a filtered AC voltage. A primary rectifier that is an active rectifier is connected to the filter and to the controller for converting the filtered AC voltage to a variable DC bus voltage. A DC storage capacitor is connected to the primary rectifier for retaining the DC bus voltage. An inverter which is of the half bridge type is coupled with the primary rectifier and the controller for converting the DC bus voltage to a primary AC voltage. A primary coil is connected to the inverter for producing an alternating magnetic field in response to receiving the primary AC voltage. A secondary coil is in communication with the primary coil for producing an induced AC voltage in response to the alternating magnetic field from the primary coil. A secondary rectifier of the full bridge type is connected to the secondary coil for rectifying the induced AC voltage from the secondary coil to a secondary DC voltage. At least one sensor is coupled with the secondary rectifier and is in communication with the controller for monitoring the secondary DC voltage and outputting a proportional signal. The controller is configured to control the primary rectifier for varying the DC bus voltage in response to the signal from the sensor and to control the inverter to produce a desired secondary DC voltage.

It is another aspect of the present disclosure to provide a method of power transfer including the step of supplying an AC voltage with an AC supply. The method continues with switching at least one rectifier switch of a primary rectifier with a controller and producing a DC bus voltage with the primary rectifier. Next, switching at least one inverter switch of an inverter with the controller at a predetermined switching frequency and producing a primary AC voltage from the variable DC bus voltage with the inverter at a desired operating frequency. Then the method includes the steps of supplying the primary AC voltage to a primary coil and producing an alternating magnetic field in response to the primary AC voltage with the primary coil. The method continues by producing an induced AC voltage in a secondary coil in response to the alternating magnetic field from the primary coil. The method proceeds with converting the induced AC voltage to a secondary DC voltage with a secondary rectifier. The method concludes with varying the DC bus voltage using the controller and varying the secondary DC voltage.

The aspects of the present disclosure may provide various advantages. For example, the power transfer system does not utilize an alternation of the switching frequency of the inverter. Consequently, the induced voltage in the secondary coil (i.e. charging voltage) may be accurately controlled. Additionally, because of a constant switching frequency, the power transfer system's overall efficiency may be maintained with minimal switching loss. As a result, the power transfer system may operate at a specific frequency required by existing engineering standards such as Society of Automotive Engineers (SAE) J-2954.

These and other aspects and areas of applicability will become apparent from the description provided herein. The description and specific examples in this summary are intended for purpose of illustration only and are not intended to limit the scope of the present disclosure

### BRIEF DESCRIPTION OF THE DRAWINGS

The drawings described herein are for illustrative purposes only of selected embodiments and not all implementations, and are not intended to limit the present disclosure to only that actually shown. With this in mind, various features and advantages of example embodiments of the present disclosure will become apparent from the following written description when considered in combination with the appended drawings, in which:

FIG. 1 is a block diagram of a power transfer system in accordance with the present disclosure;

FIG. 2 is a circuit diagram of a circuit of a power transfer system in accordance with the present disclosure;

FIG. 3 is a graphical illustration of power transfer power of a power transfer system as a function of DC bus voltage in accordance with the present disclosure;

FIG. 4 is a graphical illustration of efficiency of a power transfer system as a function of DC bus voltage in accordance with the present disclosure; and

FIG. 5 is a flowchart of a method for a power transfer system in accordance with the present disclosure.

### DETAILED DESCRIPTION OF THE ENABLING EMBODIMENTS

Detailed examples of the present disclosure are provided herein; however, it is to be understood that the disclosed examples are merely exemplary and may be embodied in various and alternative forms. It is not intended that these examples illustrate and describe all possible forms of the disclosure. Rather, the words used in the specification are words of description rather than limitation, and it is understood that various changes may be made without departing from the spirit and scope of the disclosure.

The aspects of a power transfer system disclosed herein may provide a controller configured to vary a direct current (DC) bus voltage produced from an alternating current (AC) supply to adjust the power of the system based on the system's needs at the time. Specifically, based on a battery voltage and/or current of the system detected by at least one sensor.

As those of ordinary skill in the art will understand, various features of the present disclosure as illustrated and described with reference to any of the Figures may be combined with features illustrated in one or more other Figures to produce examples of the present disclosure that are not explicitly illustrated or described. The combinations of features illustrated provide representative examples for typical applications. However, various combinations and modifications of the features consistent with the teachings of the present disclosure may be desired for particular applications or implementations.

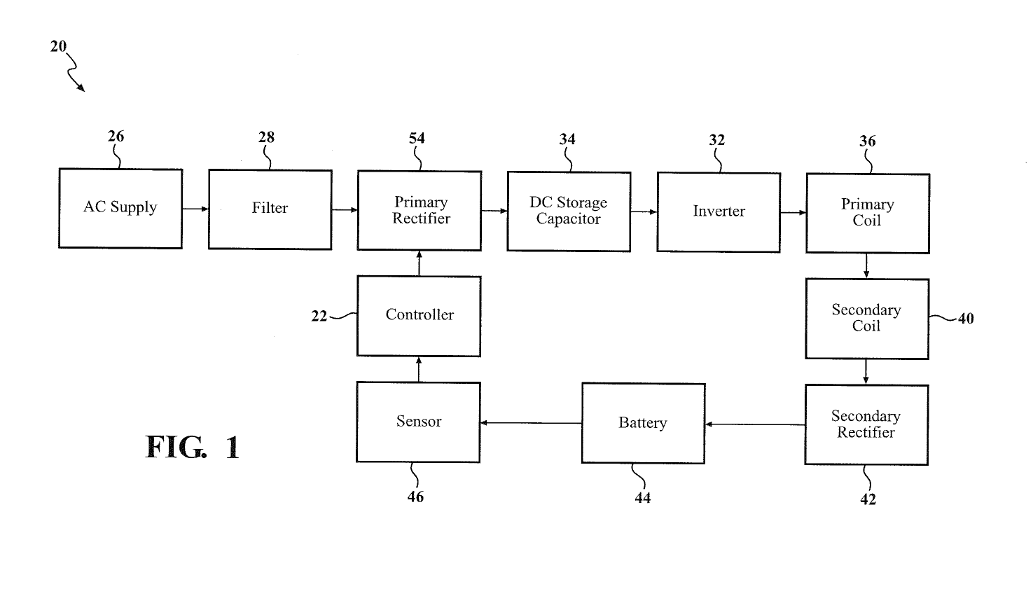

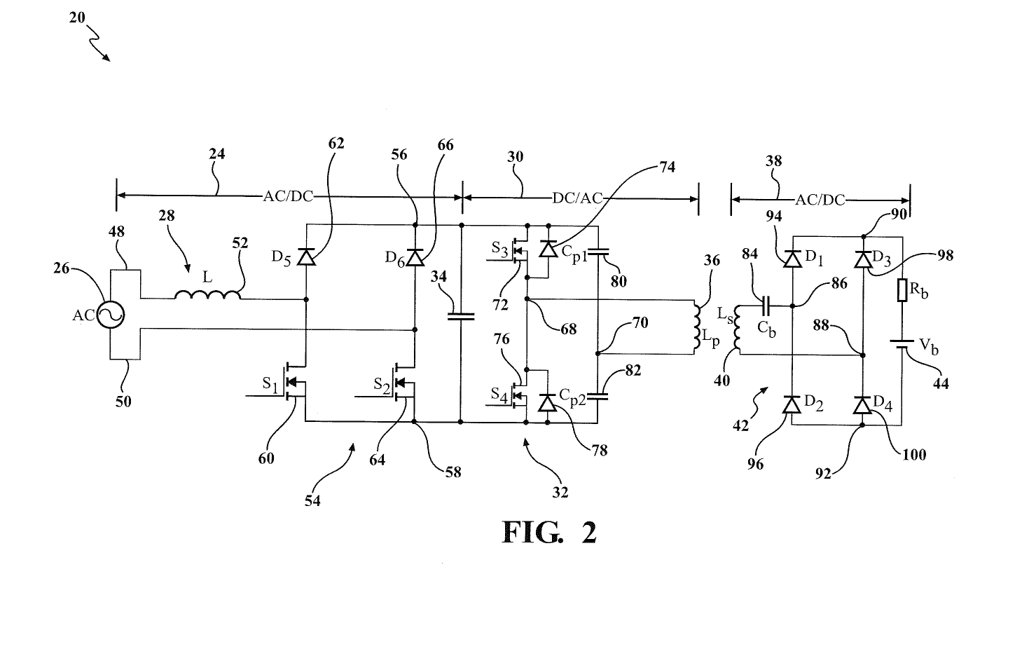

FIG. 1 illustrates a block diagram of a power transfer system 20 in accordance with the present disclosure. FIG. 2 illustrates a corresponding circuit diagram of the power transfer system 20 in accordance with the present disclosure. The power transfer system 20 includes a controller 22 may be known as a three stage system which can be broken down into three parts: 1) a primary AC/DC portion 24 which may include an AC supply 26, a filter 28, and a primary rectifier 54, 2) a primary DC/AC portion 30 which may include an inverter 32, a DC storage capacitor 34, and a primary coil 36, and 3) a secondary AC/DC portion 38 which may include a secondary coil 40, a secondary rectifier 42, a battery 44, and at least one sensor 46.

The AC supply 26, also known as an alternating current input, has a positive supply node 48 and a negative supply node 50 for providing an AC voltage across the positive supply node 48 and the negative supply node 50. The AC voltage may be produced by a power supply or by a control device having a power system. The filter 28 is connected to the AC supply 26 for filtering out or removing unwanted and undesirable frequencies from the AC voltage supplied by the AC supply 26. In one aspect of the power transfer system 20, the filter 28 is of the passive type and includes a filter inductor 52 connected between the positive supply node 48 and the primary rectifier 54. In another aspect of the power transfer system 20, the filter 28 is a passive filter utilizing an inductor-capacitor circuit configuration (not shown). It should be understood that the filter 28 may be another type of filter such as, but not limited a high pass filter, a low pass filter, a band pass filter, or no filter at all. Each type of filter 28 may remove a respective range of frequencies.

The primary rectifier 54 (i.e. primary AC-to-DC converter) defines a first primary node 56 and a second primary node 58 and is connected to the filter 28 for converting the AC voltage to a DC bus voltage. The primary rectifier 54 includes a first rectifier switch 60 connected between the second primary node 58 and the filter inductor 52 of the filter 28 and is coupled to the controller 22. According to an aspect, the first rectifier switch 60 is a metal-oxide-semiconductor field-effect transistor (MOSFET). However, it should be appreciated that the first rectifier switch 60 may be another type of switch such as, but not limited to another type of field-effect transistor (FET), or a bipolar junction transistor (BJT). In the event that no filter 28 is utilized, the first rectifier switch 60 may instead be connected between the second primary node 58 and the positive supply node 48. A first rectifier diode 62 is connected between the first primary node 56 and the filter inductor 52 of the filter 28. The primary rectifier 54 also includes a second rectifier switch 64 (e.g. FET, MOSFET, or BJT) connected between the second primary node 58 and the negative supply node 50 of the AC supply 26 and coupled to the controller 22. A second rectifier diode 66 is also connected between the first primary node 56 and the negative supply node 50 of the AC supply 26.

The DC storage capacitor 34 is connected to the primary rectifier 54 between the first primary node 56 and the second primary node 58 for storing the DC bus voltage from the primary rectifier 54 in an electrostatic field and retaining the DC bus voltage across the first primary node 56 and the second primary node 58. The DC storage capacitor 34 may be made of any type of material known in the art (e.g. ceramic or electrolytic).

The inverter 32 (i.e. DC-to-AC converter) is of the half bridge type and has a positive primary coil node 68 and a negative primary coil node 70 and is connected to the DC storage capacitor 34 for converting the DC bus voltage to a primary AC voltage. The inverter 32 includes a first inverter switch 72 (e.g. FET, MOSFET, or BJT) connected between the first primary node 56 and the positive primary coil node 68 and is connected to the controller 22. Additionally, the inverter 32 includes a first flyback diode 74 connected between the first primary node 56 and the positive primary coil node 68 in parallel with the first inverter switch 72 for preventing voltage spikes across the first inverter switch 72. The inverter 32 also includes a second inverter switch 76 (e.g. FET, MOSFET, or BJT) connected between the second primary node 58 the positive primary coil node 68 and connected to the controller 22. As with the first inverter switch 72, the inverter 32 also includes a second flyback diode 78 connected between the second primary node 58 and the positive primary coil node 68 in parallel with the second inverter switch 76 for preventing voltage spikes across the second inverter switch 76.

The primary coil 36 of the power transfer system 20 is connected between the positive primary coil node 68 and the negative primary coil node 70 of the inverter 32 for producing an alternating magnetic field in response to receiving the primary AC voltage from the inverter 32. The secondary coil 40 of the power transfer system 20 is in communication with the primary coil 36 for producing an AC induced voltage in response to the alternating magnetic field from the primary coil 36. In other words, the primary coil 36 may be considered a transmitter and the secondary coil 40 may be considered a receiver. It should be appreciated by one skilled in the art that the primary coil 36 may transfer energy between the primary coil 36 and the secondary coil 40 through electromagnetic induction. Additionally, the primary coil 36 and the secondary coil 40 may be used to realize electrical isolation.

The secondary rectifier 42 (i.e. secondary AC-to-DC converter) has a positive secondary coil node 86 and a negative secondary coil node 88 and defines a first secondary node 90 and a second secondary node 92. According to an aspect of the disclosure, the secondary rectifier 42 is of the full bridge or full wave type of rectifier. The secondary rectifier 42 includes a first bridge diode 94 coupled to the secondary coil 40 at the positive secondary coil node 86 and connected to the first secondary node 90. A second bridge diode 96 is connected to the second secondary node 92 and coupled to the secondary coil 40 at the positive secondary coil node 86. A third bridge diode 98 is connected between the negative secondary coil node 88 and the first secondary node 90. Finally, a fourth bridge diode 100 is connected between the third bridge diode 98 at the negative secondary coil node 88 and the second secondary node 92. The bridge diodes 94, 96, 98, 100 connected in this configuration provide for a rectification of the induced AC voltage from the secondary coil 40 to a secondary DC voltage.

The power transfer system 20 further includes a first primary coil tuning capacitor 80 connected between the first primary node 56 and the negative primary coil node 70. Similarly, a second primary coil tuning capacitor 82 is connected between the second primary node 58 and the negative primary coil node 70. A secondary coil tuning capacitor 84 is connected between the secondary coil 40 and the positive secondary coil node 86. Generally, coil tuning capacitors 80, 82, 84 are added to a power transfer system 20 in order to “tune” the primary coil 36 and the secondary coil 40 to provide resonance between the coils 36, 40 and increased efficiency of the power transfer system 20. According to an aspect of the disclosure, the first primary coil tuning capacitor 80 and the second primary coil tuning capacitor 82 may each have a capacitance of 0.19 microfarads (μF). According to another aspect, the secondary tuning capacitor 84 may have a capacitance of 0.12 microfarads (μF). However, it should be understood that the capacitance of the coil tuning capacitors 80, 82, 84 may be selected depending, for example, on the characteristics of the coils 36, 40. It should also be appreciated that the power transfer system 20 may include any number of coil tuning capacitors 80, 82, 84 (including zero), in series or in parallel with the primary coil 36 and/or secondary coil 40. If, for example, no secondary coil tuning capacitor 84 is utilized, the first bridge diode 94 would instead be connected between the secondary coil 40 at the positive secondary coil node 86 and the first secondary node 90. Similarly, the second bridge diode 96 would instead be connected between the secondary coil 40 at the positive secondary coil node 86 and the second secondary node 92.

The battery 44 is connected between the first secondary node 90 and the second secondary node 92 for storing the secondary DC voltage from the secondary rectifier 42. The battery 44 may have an internal resistance represented by R_{b} (FIG. 2). According to an aspect of the disclosure, the at least one sensor 46 (FIG. 1) is connected to the battery 44 and is coupled with the controller 22 for monitoring the secondary DC voltage at the battery 44 and outputs a signal proportional to a magnitude of the secondary DC voltage. The battery 44 may be responsible for powering an electric device. In an aspect of the present disclosure, the electric device may be any type of electrical device such as, but not limited to an electric vehicle, a computer, a laptop, a smart phone, a cell phone, a smart watch, smart glasses, a smart device, a tablet, a MP3 player, a digital media player. The battery 44 may receive and store the energy transferred from the primary coil 36 to the secondary coil 40 and through the secondary rectifier 42 to be used for the electric device.

According to an aspect of the disclosure, the at least one sensor 46 (FIG. 1) may communicate with the controller 22 wirelessly. For example, the controller 22, primary rectifier 54, DC storage capacitor 34, inverter 32, and primary coil 36 may be part of a “charger” and the secondary coil 40, secondary rectifier 42, battery 44, and at least one sensor 46 may part of the device or vehicle portion of the power transfer system 20 that may be remote from the “charger”. In such an arrangement, the signal of the sensor 46 is preferably communicated wirelessly, since the device or vehicle may be not wired to the “charger”. However, it should be appreciated that the at least one sensor 46 can be coupled with the controller 22 in any manner including being coupled via a wire. Additionally, it should be understood that there may also be other sensors 46 coupled to other parts of the power transfer system 20 such as, but not limited to the primary rectifier 54 and/or the primary coil 36.

The controller 22 may be configured to receive the signal from the at least one sensor 46, such as measurements relating to the voltage and/or the current at the battery 44. Referring back to FIG. 1, the controller 22 may be in communication with the first rectifier switch 60 and second rectifier switch 64 of the primary rectifier 54 and as such, may control the first rectifier switch 60 and second rectifier switch 64 of the primary rectifier 54 based on the signal from the at least one sensor 46.

In operation, the controller 22 is configured to control the first rectifier switch 60 and the second rectifier switch 64 of the primary rectifier 54 to produce a desired secondary DC voltage in response to the signal from the sensor 46. The output of the primary rectifier 54 is a variable DC bus voltage that is varied to achieve the secondary DC voltage necessary to charge the battery 44. In other words, by controlling the first rectifier switch 60 and second rectifier switch 64 of the primary rectifier 54, the DC bus voltage may be adjusted and in turn, the secondary DC voltage at the battery 44 is varied as a result based on the input received from the at least one sensor 46. By sampling the voltage and/or current, the controller 22 may determine higher or lower power is needed to charge the electric device. Consequently, the controller 22 may increase or decrease the duty cycle in operating the first rectifier switch 60 and second rectifier switch 64 of the primary rectifier 54. Increasing or decreasing the duty cycle of the first rectifier switch 60 and second rectifier switch 64 of the primary rectifier 54 produces a variable DC bus voltage. For instance, if the at least one sensor 46 detects a low secondary DC voltage, the DC bus voltage may be increased to produce an increased secondary DC voltage (i.e. a higher charging power).

As described in the prior art, power transfer systems 20 typically produce a varying output power by varying the operating frequency which may cause issues with or have an adverse effect on system efficiency. In contrast, the power transfer system 20 shown in FIGS. 1 and 2 utilizes the controller 22 to vary the DC bus voltage of the circuitry based the sensor 46 signal. In order to achieve this, the controller 22 is configured to control the first inverter switch 72 and the second inverter switch 76 of the inverter 32 at a predetermined switching frequency to create the primary AC voltage of the inverter 32 at a desired operating frequency. For example, the desired operating frequency may be chosen from a specific range (e.g. 70-100 kHz) or a specific operating frequency such as 80 kHz as required by wireless charging specifications such as J-2954 promulgated by the Society of Automotive Engineers (SAE). In any event, the switching frequency of the inverter 32 is intended to remain constant as the DC bus voltage is varied.

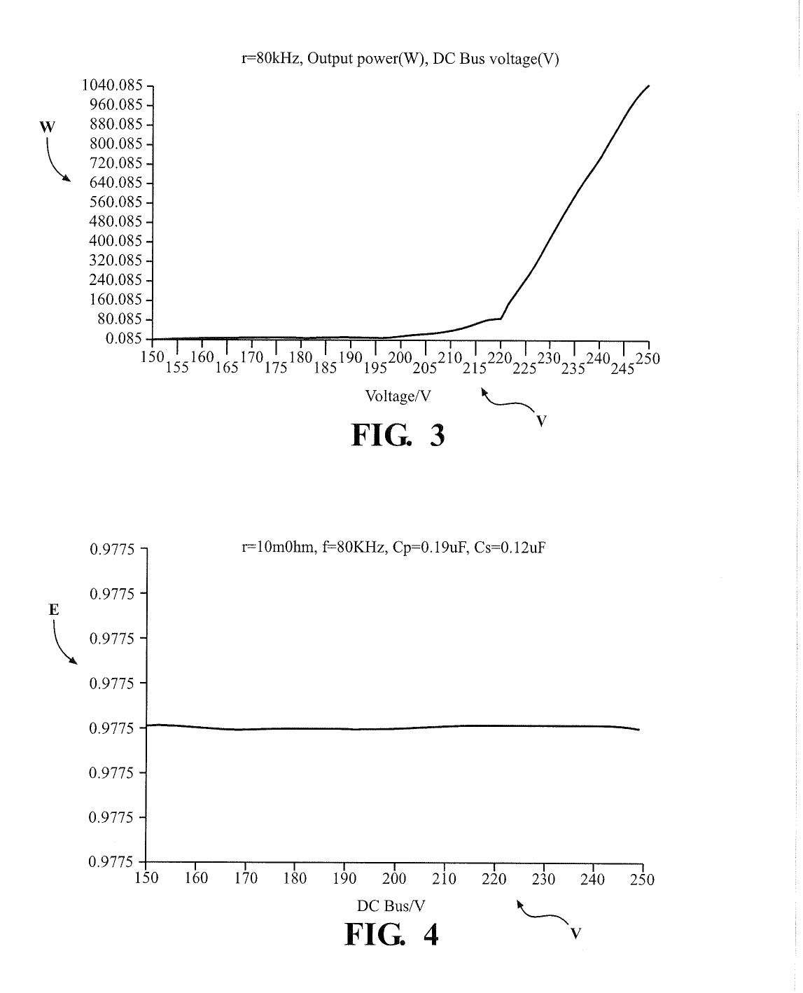

FIG. 3 is a graphical illustration of the output power of a power transfer system 20 as a function of the DC bus voltage in accordance with the present disclosure. In particular, FIG. 3 shows the relationship between the DC bus voltage (in Volts), indicated as V and the output power (in Watts), indicated as W while the switching frequency of the inverter 32 of the power transfer system 20 is maintained to produce a desired operating frequency of 80 kHz. As discussed above, as the DC bus voltage increases or varies based on signal of the sensor 46, the output power or power transfer power of the power transfer system 20 increases as illustrated.

FIG. 4 is a graphical illustration of the efficiency of the power transfer system 20 as a function of the DC bus voltage in accordance with the present disclosure. In particular, FIG. 4 illustrates the efficiency, indicated as E, of the power transfer system 20 as a function of the DC bus voltage, indicated as V, based on the operation of the power transfer system 20 as discussed above in FIGS. 1-3. As shown, the power transfer system 20 operates with a constant efficiency of 97.75% as the DC bus voltage varies or increases and as the output power of the system increases. Meanwhile, the frequency of the power transfer system 20 may be maintained at 80 kHz.

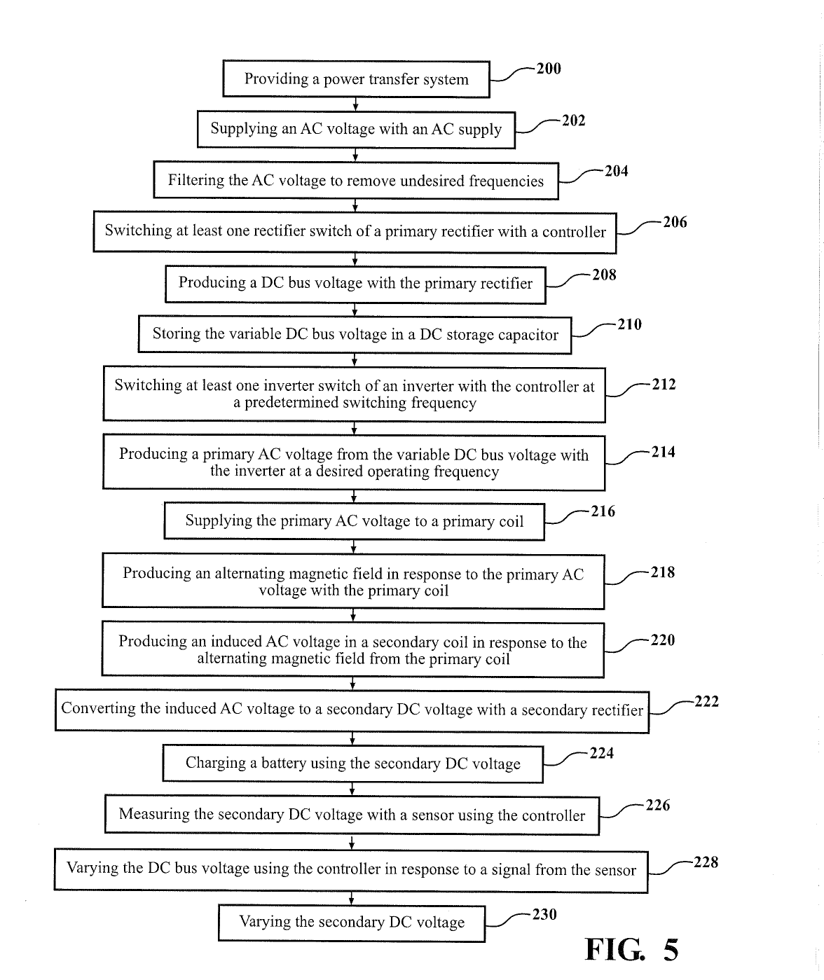

FIG. 5 is a flowchart of a method for operating a power transfer system 20 in accordance with the present disclosure. The method may include 200 providing a power transfer system 20 as described above. The method may include the step of 202 supplying an AC voltage with an AC supply 26. As disclosed, the AC supply 26 may be a power supply or a device controller 22 having a power supply. The method may also include the step of 204 filtering the AC voltage to remove undesired frequencies. It should be understood that the method may be alternatively carried out without filtering. The method proceeds with the steps of 206 switching at least one rectifier switch of a primary rectifier 54 (i.e. AC/DC converter) with a controller 22 and 208 producing a DC bus voltage with the primary rectifier 54. The method may also include 210 storing the variable DC bus voltage in a DC storage capacitor 34. It should be appreciated that this step could be omitted. The method continues with the steps of 212 switching at least one inverter 32 switch of an inverter 32 with the controller 22 at a predetermined switching frequency and 214 producing a primary AC voltage from the variable DC bus voltage with the inverter 32 at a desired operating frequency. Next, 216 supplying the primary AC voltage to a primary coil 36 and 218 producing an alternating magnetic field in response to the primary AC voltage with the primary coil 36. The next step is 220 producing an induced AC voltage in a secondary coil 40 in response to the alternating magnetic field from the primary coil 36. The method continues by 222 converting the induced AC voltage to a secondary DC voltage with a secondary rectifier 42 (i.e. AC/DC converter) and 224 charging a battery 44 using the secondary DC voltage. The method may also include 226 measuring the secondary DC voltage with a sensor 46 using the controller 22. It should be understood that the sensor 46 may instead be configured to measure current rather than voltage or the power transfer system 20 may also include multiple sensors 46. The method concludes by 228 varying the DC bus voltage using the controller 22 in response to a signal from the sensor 46 and 230 varying the secondary DC voltage. In other words, the controller 22 may be in electrical communication with the at least one sensor 46 (e.g. wirelessly) and may vary the DC bus voltage to adjust the power output of the power transfer system 20 to charge the battery 44 of the electric device (e.g. electric vehicle or electronic device) based on the secondary DC voltage at the battery 44 detected by the sensor 46.

It should also be appreciated that the power transfer system 20 described herein is not limited to wireless charging. But may also be used for other applications such as, but not limited to inductive heating, as an isolated DC/DC converter, as a conventional battery charger, or any power electronics converters where the DC bus voltage is variable. In the case of the conventional battery charger, it should be understood that the primary coil 36 in communication with the secondary coil 40 comprises a transformer. Therefore, the power transfer system 20 could alternatively be used in a conventional battery charging or power transfer application in which the electric device (e.g. electric vehicle, electronic device, etc.) is being charged via a wired connection. Any gap or spacing between the primary coil 36 and secondary coil 40 in such an application would provide desirable isolation, for example.

While examples of the disclosure have been illustrated and described, it is not intended that these examples illustrate and describe all possible forms of the disclosure. Rather, the words used in the specification are words of description rather than limitation, and it is understood that various changes may be made without departing from the spirit and scope of the disclosure. Additionally, the features and various implementing embodiments may be combined to form further examples of the disclosure.

The foregoing description is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Those skilled in the art will recognize that the inventive concept disclosed in association with an example power transfer system 20 can likewise be implemented into many other electrical systems. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

What is claimed is:

1. A power transfer system for transferring power from an AC supply outputting an AC voltage comprising;
a controller,
a primary rectifier defining a first primary node and a second primary node and connected to the AC supply for converting the AC voltage to a DC bus voltage,
an inverter coupled with said primary rectifier and said controller for converting the DC bus voltage to a primary AC voltage,
a primary coil connected to said inverter for producing an alternating magnetic field in response to receiving the primary AC voltage,
a secondary coil in communication with said primary coil for producing an induced AC voltage in response to the alternating magnetic field from said primary coil,
a secondary rectifier connected to said secondary coil for rectifying the induced AC voltage from said secondary coil to a secondary DC voltage,
said primary rectifier including a first rectifier switch connected between said second primary node and the AC supply and coupled to said controller and a first rectifier diode connected between said first primary node and the AC supply,
said primary rectifier including a second rectifier switch connected between said second primary node and the AC supply and coupled to said controller and a second rectifier diode connected between said first primary node and the AC supply,
said controller configured to control said first rectifier switch and said second rectifier switch for varying the DC bus voltage to produce a desired secondary DC voltage.

2. A power transfer system as set forth in claim 1 wherein said inverter includes a first inverter switch connected between said first primary node and said primary coil and connected to said controller and a first flyback diode connected between said first primary node and said primary coil in parallel with said first inverter switch for preventing voltage spikes across said first inverter switch and a second inverter switch connected between said second primary node and said primary coil and connected to said controller and a second flyback diode connected between said second primary node and said primary coil in parallel with said second inverter switch for preventing voltage spikes across said second inverter switch.

3. A power transfer system as set forth in claim 2 further including a battery connected to said secondary rectifier for storing the secondary DC voltage from said secondary rectifier.

4. A power transfer system as set forth in claim 3 further including at least one sensor connected with said battery and coupled with said controller for monitoring the secondary DC voltage at said battery and outputting a signal proportional to the secondary DC voltage and wherein said controller is configured to control said first rectifier switch and said second rectifier switch for varying the DC bus voltage in response to the signal from said sensor to produce the desired secondary DC voltage.

5. A power transfer system as set forth in claim 2 wherein said controller is configured to control said first inverter switch and said second inverter switch of said inverter at a predetermined switching frequency to create the primary AC voltage of said inverter at a desired operating frequency.

6. A power transfer system as set forth in claim 5 wherein said desired operating frequency is between 70 and 100 kHz.

7. A power transfer system as set forth in claim 1 wherein said secondary rectifier has a positive secondary coil node and a negative secondary coil node and defines a first secondary node and a second secondary node and includes a first bridge diode coupled to said secondary coil at said positive secondary coil node and connected to said first secondary node and a second bridge diode connected to said second secondary node and coupled to said secondary coil at said positive secondary coil node and a third bridge diode connected between said negative secondary coil node and said first secondary node and a fourth bridge diode connected between said third bridge diode at said negative secondary coil node and said second secondary node.

8. A power transfer system as set forth in claim 7 further including a first primary coil tuning capacitor connected between said first primary node and said negative primary coil node and a second primary coil tuning capacitor connected between said second primary node and said negative primary coil node and a secondary coil tuning capacitor connected between said secondary coil and said positive secondary coil node for tuning resonance between said primary coil and said secondary coil.

9. A power transfer system as set forth in claim 1 further including a DC storage capacitor connected to said primary rectifier between said first primary node and said second primary node for storing the DC bus voltage from the primary rectifier in an electrostatic field across said first primary node and said second primary node.

10. A power transfer system for transferring power from an AC supply outputting an AC voltage comprising;
a controller,
a filter connected to the AC supply for filtering out undesirable frequencies from the AC voltage and outputting a filtered AC voltage,
a primary rectifier being an active rectifier and connected to said filter and said controller for converting the filtered AC voltage to a variable DC bus voltage,
a DC storage capacitor connected to said primary rectifier for retaining the DC bus voltage,
an inverter being of the half bridge type and coupled with said primary rectifier and said controller for converting the DC bus voltage to a primary AC voltage,
a primary coil connected to said inverter for producing an alternating magnetic field in response to receiving the primary AC voltage,
a secondary coil in communication with said primary coil for producing an induced AC voltage in response to the alternating magnetic field from said primary coil,
a secondary rectifier of the full bridge type coupled to said secondary coil for rectifying the induced AC voltage from said secondary coil to a secondary DC voltage,
at least one sensor coupled with said secondary rectifier and in communication with said controller for monitoring the secondary DC voltage and outputting a proportional signal, and
said controller configured to control said primary rectifier for varying the DC bus voltage in response to the signal from said sensor and to control said inverter to produce a desired secondary DC voltage.

11. A power transfer system as set forth in claim 10 wherein the AC supply has a positive supply node and a negative supply node and said primary rectifier defines a first primary node and a second primary node and said primary rectifier includes a first rectifier switch connected between the second primary node and the positive supply node of the AC supply and coupled to said controller and a first rectifier diode connected between said first primary node and the positive supply node of the AC supply and a second rectifier switch connected between said second primary node and the negative supply node of the AC supply and coupled to said controller and a second rectifier diode connected between said first primary node and the negative supply node of the AC supply.

12. A power transfer system as set forth in claim 11 wherein said inverter includes a first inverter switch connected between said first primary node and said primary coil and connected to said controller and a first flyback diode connected between said first primary node and said primary coil in parallel with said first inverter switch for preventing voltage spikes across said first inverter switch and a second inverter switch connected between said second primary node and said primary coil and connected to said controller and a second flyback diode connected between said second primary node and said primary coil in parallel with said second inverter switch for preventing voltage spikes across said second inverter switch.

13. A power transfer system as set forth in claim 10 wherein said secondary rectifier has a positive secondary coil node and a negative secondary coil node and defines a first secondary node and a second secondary node and includes a first bridge diode connected between said secondary coil at said positive secondary coil node and said first secondary node and a second bridge diode connected between said second secondary node and said secondary capacitor at said positive secondary coil node and a third bridge diode connected between said negative secondary coil node and said first secondary node and a fourth bridge diode connected between said third bridge diode at said negative secondary coil node and said second secondary node and wherein said controller is configured to control said first inverter switch and said second inverter switch of said inverter at a predetermined switching frequency to create the primary AC voltage of said inverter.

14. A power transfer system as set forth in claim 13 further including a first primary coil tuning capacitor connected between said first primary node and said negative primary coil node and a second primary coil tuning capacitor connected between said second primary node and said negative primary coil node and a secondary coil tuning capacitor connected between said secondary coil and said positive secondary coil node for tuning resonance between said primary coil and said secondary coil.

15. A power transfer system as set forth in claim 10 further including a battery connected to said secondary rectifier for storing the secondary DC voltage from said secondary rectifier.

16. A method of power transfer comprising the steps of:
supplying an AC voltage with an AC supply,
switching at least one rectifier switch of a primary rectifier with a controller,
producing a DC bus voltage with the primary rectifier,
switching at least one inverter switch of an inverter with the controller at a predetermined switching frequency,
producing a primary AC voltage from the variable DC bus voltage with the inverter at a desired operating frequency,
supplying the primary AC voltage to a primary coil,
producing an alternating magnetic field in response to the primary AC voltage with the primary coil,
producing an induced AC voltage in a secondary coil in response to the alternating magnetic field from the primary coil,
converting the induced AC voltage to a secondary DC voltage with a secondary rectifier,
varying the DC bus voltage using the controller, and
varying the secondary DC voltage.

17. A method of power transfer as set for in claim 16 further including the step of measuring the secondary DC voltage with a sensor using the controller and wherein the step of varying the DC bus voltage using the controller is defined as varying the DC bus voltage using the controller in response to a signal from the sensor.

18. A method of power transfer as set for in claim 16 further including the step of filtering the AC voltage to remove undesired frequencies.

19. A method of power transfer as set for in claim 16 further including the step of charging a battery using the secondary DC voltage.

20. A method of power transfer as set forth in claim 16 further including the step of storing the variable DC bus voltage in a DC storage capacitor.
